(19) United States
(12) Patent Application Publication
(10) Pub. No.: US 2025/0332478 A1
(43) Pub. Date: Oct. 30, 2025

(54) SEMI-OCCLUDED VOCAL TRACT EXERCISE DEVICE WITH NONLINEAR-PATH AND ADJUSTABLE RESISTANCE

(71) Applicant: Joseph Patrick Lundquist, Volente, TX (US)

(72) Inventor: Joseph Patrick Lundquist, Volente, TX (US)

(21) Appl. No.: 19/261,812

(22) Filed: Jul. 7, 2025

Related U.S. Application Data
(63) Continuation-in-part of application No. 18/217,939, filed on Jul. 3, 2023, now Pat. No. 12,350,550.
(63) Continuation-in-part of application No. 17/083,298, filed on Oct. 29, 2020, now Pat. No. 11,794,072.
(63) Continuation-in-part of application No. 16/105,174, filed on Aug. 20, 2018, now abandoned.

(51) Int. Cl. A63B 23/18

(52) U.S. Cl. CPC A63B 23/18

(57) ABSTRACT

An SOVT (semi-occluded vocal tract) exercise device is disclosed, consisting of a compact tubular body with an internal nonlinear airflow path that significantly extends the effective path length of exhaled air. In preferred embodiments a helical partition or insert inside the tube creates a tortuous channel, providing enhanced back-pressure and inertance for vocal training. The device further includes one or more adjustable vent apertures along the tube's wall, which can be selectively opened or closed (for example, by finger, plug, valve, or sleeve) to vary the resistance and/or effective tube length in real time, Certain embodiments incorporate a deformable or one-way valve element at the distal end of the channel that flexes or oscillates under airflow, introducing a pulsating resistance for additional therapeutic benefit. The modular design facilitates easy disassembly for cleaning, interchangeability of inserts or end elements, and portability for voice therapy, respiratory training, or musical applications.

### CROSS-REFERENCE TO RELATED APPLICATIONS

This application is a continuation-in-part of U.S. patent application Ser. No. 18/217,939, filed Jul. 3, 2023, which is a continuation-in-part of Ser. No. 17/083,298, filed Oct. 29, 2020 (now U.S. Pat. No. 11,794,072), which is a continuation-in-part of U.S. patent application Ser. No. 16/105,174, filed Aug. 20, 2018. This application also claims the benefit of and priority of all other applications in this family to the maximum allowable extent. The disclosures of all the foregoing applications are hereby incorporated by reference in their entirety. Common subject matter from the prior applications in this family is incorporated herein by reference to the extent not inconsistent with the present disclosure.

### TECHNICAL FIELD OF THE INVENTION

The present invention relates generally to vocal training and therapy devices, and more specifically to an improved apparatus for performing semi-occluded vocal tract (SOVT) exercises.

### COPYRIGHT AND TRADEMARK NOTICE

A portion of the disclosure of this patent application may contain material that is subject to copyright protection. The owner has no objection to the facsimile reproduction by anyone of the patent document or the patent disclosure, as it appears in the Patent and Trademark Office patent file or records, but otherwise reserves all copyrights whatsoever.

Certain marks referenced herein may be common law or registered trademarks of third parties affiliated or unaffiliated with the applicant or the assignee. Use of these marks is by way of example and should not be construed as descriptive or to limit the scope of this invention to material associated only with such marks.

### BACKGROUND OF THE INVENTION

The present invention relates generally to vocal training and therapy devices, and more specifically to an improved apparatus for performing semi-occluded vocal tract (SOVT) exercises. SOVT exercises involve phonating or exhaling through a partially closed vocal tract (such as through a narrow straw or tube) to stretch and balance the vocal folds while reducing stress on them. This technique, often referred to as straw phonation, has been shown in voice science to yield numerous therapeutic benefits. By partially occluding the vocal tract, one can increase the inertance (acoustic inertia) of the airflow and create beneficial back pressure on the vocal tract and vocal folds. Such back pressure helps the vocal cords vibrate more efficiently and in a healthier manner, promoting proper alignment and reducing vocal strain. Studies have demonstrated that SOVT exercises foster improved phonation by increasing vocal tract inertance, enhancing acoustic focus, and developing better vocal muscle memory.

Traditional SOVT training is often done using simple drinking or stirring straws of small diameter. However, ordinary disposable straws are not ideal for repeated use as therapeutic or training tools. They are typically flimsy, non-standard in size, and can harbor bacteria if reused. Prior art solutions have introduced durable, reusable SOVT trainer tubes made of metal or other robust materials to address these concerns. For example, the inventor's earlier devices provide a resilient metal “vocal straw” that is portable, wear-resistant, and even wearable as a necklace or clip for convenience. Such devices often feature antimicrobial materials (e.g. copper or silver alloys) to improve hygiene during repeated use. They standardize dimensions (length and inner diameter) to ensure consistent training conditions, overcoming the inconsistency and sanitary issues of makeshift straw use. These straight-tube SOVT trainers successfully improve durability and portability, fulfilling a need for a reliable vocal exercise tool.

Despite the advances of durable straight-tube trainers, they remain limited in certain respects. A fixed-diameter, fixed-length tube offers only a single resistance level, determined by its geometry. Users have varying lung capacities and therapeutic needs; a straw that is suitably challenging for one person may be too easy or too difficult for another. To increase resistance with a simple tube, one must either reduce the inner diameter (making it harder to phonate) or increase the tube's length (which can reduce portability and/or discreet use). Indeed, it is known that the back-pressure and inertive effects in SOVT training are directly related to the tube's length and diameter; longer and narrower tubes yield greater resistance and higher inertance. However, making a device significantly longer or extremely narrow can be impractical an overly long tube is cumbersome to carry, and an overly narrow tube can be uncomfortable or impossible for some users to blow through or clean. Moreover, a straight open tube provides steady resistance but no variation or modulation in the airflow; some therapeutic approaches might benefit from dynamic resistance (e.g. oscillatory or pulsating back pressure) to further massage and exercise the vocal folds.

The clinical applications for SOVT training extend far beyond vocal performance to include respiratory therapy for conditions such as chronic obstructive pulmonary disease (COPD), muscle tension dysphonia, vocal fold paralysis, and post-surgical vocal rehabilitation. Medical professionals and speech-language pathologists increasingly recognize that controlled expiratory resistance training can strengthen respiratory muscles, improve vocal fold coordination, and reduce pathological vocal behaviors. Similarly, instrumental music educators have discovered that SOVT principles can rapidly teach proper breath support to developing woodwind and brass players, helping students understand the relationship between airflow pressure and sound production. However, existing devices lack the versatility to serve this broader therapeutic and pedagogical market effectively.

Accordingly, there is a need for an improved SOVT exercise device that maintains the portability and durability of prior designs while offering enhanced and adjustable resistance levels. Ideally, such a device would increase the effective airflow path length (and thus resistance) without requiring a much larger form factor, and would allow the user to fine-tune or modulate the resistance to suit their training or therapeutic goals. It would also be beneficial for the device to introduce vibratory or oscillatory resistance features to augment the therapeutic effect on the vocal folds. The present invention addresses these needs by providing a comprehensive SOVT training system featuring an internal helical airflow path, adjustable venting mechanisms, and modular resistance elements that create a tortuous, user-modulable airflow route suitable for vocal training, respiratory therapy, and instrumental music education. The device accommodates a wide range of users from professional vocalists to COPD patients to beginning band students, with resistance profiles that can be precisely adjusted for therapeutic or pedagogical goals.

Unmet Need and Distinction from Known Devices: Various semi-occluded vocal-tract (SOVT) tools are known, including disposable drinking straws, straight-tube “vocal straws” or “singing straws,” and tubes and devices for water-bubbling exercises such as the Lax Vox® technique. While these approaches provide a fixed, single-level resistance, they require multiple devices or cumbersome water containers to vary training intensity. Further, certain devices aim to vary effective vocal tract length and airflow resistance through means such as telescoping straws optionally with adjustable valves on the distal end, and linear-air-path devices with adjustable valves. No prior device combines an internal spiral or helical airflow pathway that substantially lengthens the effective acoustic column within a compact tube together with user-selectable venting that enables real-time resistance adjustment in a single, portable unit. The present invention satisfies this gap by integrating a tortuous airflow path (removable or integral) with vents that may be selectively occluded, thereby furnishing both enhanced inertive reactance and on-the-fly adjustability unavailable in the prior art.

### SUMMARY OF THE INVENTION

In view of the above-described limitations of existing semi-occluded vocal tract trainers, the present invention provides a helical-path SOVT exercise device that greatly increases and modulates expiratory resistance in a compact form. In a preferred embodiment, the invention is an apparatus comprising a rigid hollow tube and a removable helical insert that together define a tortuous internal airflow channel. The tube serves as the main body of the device, having a proximal end adapted to be held at the user's mouth and a distal end that is closed off internally by the insert. The insert is shaped as a helicoid (spiral) partition that fits snugly inside the tube, effectively dividing the tube's interior into a winding path that travels down one side of the insert and back up the other side. Air entering at the proximal end is forced to follow this helical path: it flows downward along one face of the spiral insert, reaches the bottom where the path turns around, and then flows upward along the opposite face of the insert back toward the top. By folding the airflow back onto itself within the tube, the device doubles the effective path length (or more, depending on the spiral pitch and air path diameter or cross-section area) without significantly increasing the tube's external length. This increased path length and the accompanying surface friction yield substantially greater airflow resistance and more gently compressible back-pressure for a given tube size, enhancing the SOVT exercise benefits.

A helical insert creates a tortuous airflow path by forcing exhaled air to follow a corkscrew pattern within the tube. In preferred embodiments, the insert comprises a spiral-shaped vane or twisted ribbon that press-fits within the tube's interior, effectively multiplying the airflow path length compared to a straight passage of equal tube length. The helical geometry induces rotational airflow components that enhance acoustic feedback and vocal tract inertance.

An insert includes sealing features to ensure that air does not simply leak around it instead of traversing the spiral channel. In preferred embodiments, the insert is a one-piece silicone helicoid that engages the inner wall of the tube along the entire spiral. This creates an airtight (or substantially and sufficiently air-restrictive) barrier between the descending and ascending airflow passages. The sealing effectiveness may be enhanced through various means including continuous peripheral ribs, segmented sealing elements, multiple contact points along the spiral path, or elastomeric gasket systems that accommodate manufacturing tolerances while maintaining consistent airflow isolation. The insert design permits various geometric configurations including but not limited to single-turn spirals for minimal resistance increase, multi-turn helixes for maximum path extension, or variable-pitch spirals that create non-uniform resistance profiles along the airflow path. The insert may also incorporate an integrated end cap or plug at its distal end. This plug fits into or against the distal opening of the tube, thereby closing off the distal end and forcing the airflow to reverse direction within the tube. In essence, the combination of the sealing spiral and the distal plug confines the air to the tortuous channel defined by the insert, greatly increasing resistance compared to an open straight tube. The insert is designed to be removable, allowing for easy cleaning and interchangeability. For example, inserts of different spiral geometries or materials can be swapped in to adjust the baseline resistance or other characteristics, providing versatility for users at different skill levels or therapeutic needs.

In another aspect, the device provides adjustable airflow venting along the tube's length to further modulate resistance. The rigid tube (which is preferably of an oval cross-section in the exemplary design) is formed with one or more vent apertures or holes through its outer wall. Each vent hole opens into the internal airflow channel at a certain point along the path. These vents serve as alternate outlets for the airflow and can be selectively occluded or opened by the user to adjust how much of the helical channel is utilized during exhalation. For instance, if a vent located partway down the tube is opened (exposed to the atmosphere), the exhaled air will escape once it reaches that vent, rather than continuing all the way to the bottom of the channel. In effect, opening a vent “short-circuits” the path and reduces the resistance, while closing the vent forces air to travel the full helical route, maximizing resistance. By providing multiple spaced vent holes (for example, at different longitudinal positions along the tube corresponding to 25%, 50%, 75% of the full path length), the device allows the user to dial in a desired resistance level simply by covering or uncovering certain vents. The vent holes may be small (e.g., between one and a few millimeters in diameter) and arranged on an outer face of the oval tube so they are easily reachable with a fingertip during use. In basic use, a singer or patient can vary finger pressure over a vent to subtly modulate the resistance as they phonate, or uncover a hole entirely to significantly drop resistance when needed (such as to release pressure or as a training interval).

The invention further provides embodiments incorporating controlled oscillatory resistance through a deformable element positioned at the distal end of the device. This element interfaces with a double helical airflow path to create mechanical oscillation comparable to complex respiratory therapy devices while maintaining the fundamental simplicity of the removable insert design. The deformable element may comprise a thin silicone membrane and/or a compressible resilient mass such as a gel secured across a frame positioned to interface with the converging airflow paths. Under expiratory pressure, the membrane flexes outward until reaching a threshold pressure, then releases air and returns to position, creating oscillatory cycles.

Optionally, the invention includes accessories or mechanisms to occlude the vent holes in a more controlled manner than using a finger alone. In some embodiments, removable plugs are provided which can snugly fit into the vent apertures to seal them. A user might plug or unplug specific holes to set a fixed resistance profile for a practice session. In other embodiments, a rotatable sleeve or collar is arranged around the outside of the tube, the sleeve having one or more openings that can be aligned or misaligned with the vent holes (by rotating the sleeve) to open or close them—much like a rotatable air regulator. Another variant is a sliding shutter or band that slides longitudinally along the tube to cover or uncover the vent holes. Optionally, in certain embodiments the device will not utilize finger holes for adjustment. The device may comprise a lever and/or valve positioned in their place to adjust resistance.

In certain therapeutic and educational embodiments, the device incorporates specialized adapter systems that enable compatibility with standard medical nebulizer connections, instrumental mouthpieces for woodwind and brass instruments, or pediatric-sized interfaces for younger users. These adapter systems maintain the fundamental resistance characteristics while expanding the device's utility across diverse user populations. The adapters can be configured with their own resistance-modifying features, such as integrated flow restrictors or pressure relief valves, that work in conjunction with the main helical channel to achieve specific therapeutic or training objectives. These various adjustable closure mechanisms allow for quick changes in resistance without needing to constantly use one's finger, and they can secure a chosen configuration (preventing unintentional exposure of a vent during use).

In certain therapeutic embodiments, the device further comprises specialized adapters enabling integration with medical equipment. Such an assembly may comprise a standard connector, for non-limiting examples, such as a fixed elbow connector or a Y-piece connector, allowing concurrent connection to both a nebulizer and the device. A nebulizer-compatible assembly may comprise dual check valve mechanisms: a first one-way valve permitting saline- and/or medication-laden airflow from a standard nebulizer outlet into the device while preventing backflow, and a second one-way valve allowing expiratory flow into the device while preventing inspiratory flow reversal. Such a dual check valve mechanism may be incorporated into a specialized adapter, such as in the adapter of FIG. 5, or may be components added into an assembly through connection to other components. Assemblies comprising dual check valve mechanisms enable concurrent delivery of aerosolized saline and/or medications during SOVT exercises, particularly beneficial for not only singers who are warming up their voice, but also for patients with comorbid respiratory and voice disorders. Preferred embodiments made to be compatible with medical devices will accommodate global standard 22 mm ISO nebulizer mouthpiece connections while maintaining the therapeutic resistance characteristics of the SOVT device. This allows for immense additional functionality opportunities at relatively low cost, in the ability to connect and combine the device with widely available medical equipment.

The device may incorporate multiple modalities of passive airflow modulation including flutter valves, oscillatory membranes, and resonant chambers. Flutter valve implementations range from simple flexible diaphragms covering vent apertures to sophisticated multi-stage oscillation systems. In one embodiment, a centrally-located flutter mechanism resembling a Heimlich valve extends longitudinally through the helical channel, creating oscillatory resistance directly within the primary airflow path. This central flutter element may comprise a lightweight membrane or reed that deflects rhythmically under expiratory pressure, producing both audible feedback and tactile vibration that propagates through the helical channel to provide enhanced proprioceptive awareness for the user. Certain embodiments may forego the use of a tortuous-path insert. Alternative embodiments position flutter elements at various locations including the proximal mouthpiece area for immediate feedback, intermediate positions along the helical path for graduated resistance modulation, or at the terminal end of the device where oscillatory backpressure can be precisely controlled. The flutter frequency and amplitude can be tuned through material selection, geometric proportions, and mounting tension to achieve specific therapeutic frequencies that optimize vocal fold massage, respiratory muscle engagement, or instrumental embouchure development.

The device of the present invention is further designed with practical user-friendly features. The tube, being rigid and preferably metallic (such as stainless steel or a copper alloy), is durable and can be coated or made with antimicrobial materials to ensure cleanliness (for instance, using materials with an oligodynamic effect that naturally limit microbial growth). The cross-sectional shape of the tube is optionally but preferably oval (elliptical), which offers a couple of advantages: even in absence of an optional mouthpiece, it provides a comfortable fit at the mouth and against the lips, it prevents the device from rolling when set down, and it helps key the orientation of the insert within (so that the insert's spiral aligns correctly with any vent hole positions). Certain embodiments may be configured to direct air from a user's mouth to a particular portion of the oval, rather than uniformly into the middle of the tube. Certain embodiments may have an insert which is configured on the proximal end to accept airflow into one particular direction and not allow airflow into the other; for example in an insert shaped primarily like a double helix, the insert may at the proximal end allow airflow only into one of the two sides of the “twisted ribbon.” The removable insert is in many embodiments made of medical-grade silicone or a similarly resilient elastomer. This material provides an airtight seal against the tube wall via its own integrated body acting as a peripheral rib, and it is easily washable. Silicone inserts also allow for vibrant coloring, complex surface geometry, or softness for tactile feedback, if desired. The insert may be fabricated with a helical twist or screw-like shape, and the user can insert or remove it for cleaning or for swapping different inserts. In alternate constructions, the insert can be made of more rigid materials: for example, a rigid metallic helicoid insert may be used for maximum durability and stiffness, in which case an elastomeric gasket can be provided around its edges to maintain the necessary seal with the tube's interior. In another variant, the insert assembly comprises a rigid support structure combined with a full-length elastomeric sleeve—e.g., a metal spine or coil that is over-molded or housed within a tubular silicone sleeve that lines the entire length of the tube's interior. In this design, the elastomeric sleeve itself might form the spiral channel (via an internal partition wall or molded groove), and the internal metal support ensures the insert keeps its shape and position during use. In other embodiments both the sleeve and insert are made of flexible material for maximum flexibility of the device. These nonlimiting examples illustrate the range of possible materials and constructions that can achieve the core function of creating a sealed, helical airflow path inside a rigid tube.

For user convenience and portability, certain embodiments of the device include features to make it wearable or easy to carry. For instance, the distal end of the insert (which includes the end cap that blocks the tube) can be formed with an integral eyelet or bail. When the insert is installed, this eyelet may protrude slightly from the distal end of the tube (or sit flush with it), allowing the entire assembled device to be attached to a keychain, lanyard, or necklace. The portability features extend to complete kit configurations where the primary device body, multiple helical inserts of varying resistance levels, flutter valve and/or deformable distal end modules, instrumental adapters, and maintenance tools are integrated into a compact carrying case suitable for clinical settings, educational environments, or personal use. It is contemplated that certain embodiments comprise a cap which covers the proximal end and optionally the mouthpiece to protect the device from the elements. The kit approach enables healthcare providers to maintain standardized equipment across multiple patients while allowing individualized resistance programming, and permits music educators to efficiently manage equipment for entire instrument sections during group instruction sessions. In one embodiment, the eyelet is a small loop molded as part of the silicone insert's end cap, strong enough to hold the device's weight. In another embodiment, the tube itself carries an attached ring or hook (for example, a small metal bail affixed to the exterior of the tube near the top or bottom) to enable the device to hang from a cord. These wearable features ensure that vocal professionals or patients can keep the trainer handy (around the neck or in a pocket) and integrate regular SOVT practice into their daily routine without fear of losing the device. It is contemplated that embodiments as presently disclosed may comprise integrated or removable wearable elements (e.g. a ring, clip, bail, and/or necklace) and/or venting holes configured as disclosed in prior filings in this patent family of which the present disclosure claims the benefit.

Overall, the present invention provides a maximally versatile SOVT exercise apparatus. It preserves the benefits of prior portable vocal trainers—being small, robust, and hygienic—while introducing a host of new capabilities through its helical airflow path, component design, and adjustable resistance elements. The design is intended to be fully enabling without limiting the scope of potential variations. Throughout this disclosure, any reference to specific materials, shapes, or configurations should be understood as illustrative of certain embodiments, not restrictive of the invention as a whole. For example, while a helicoid insert and oval tube are a preferred configuration, in alternative embodiments the tube could be of another cross-sectional shape (circular, rectangular, etc.) and the internal airflow path could be defined by different structures that achieve a similar tortuous route (such as interlocking components or multiple baffles). Likewise, features like vent hole closures and flutter valves may be included or omitted in various combinations according to the needs of particular users. Such modifications and adaptations are within the spirit of this invention, whose scope is defined by the forthcoming claims. In certain preferred embodiments, closure may be provided by the user's own finger or fingers.

Throughout this disclosure, various adjustment mechanisms, valve assemblies, and actuation means are described for illustrative purposes. It should be understood that the specific mechanical implementations shown (including twist-advancement mechanisms, click-stop detents, valve types, and adjustment means) are exemplary and non-limiting. Any functionally equivalent mechanism known in the art may be substituted without departing from the scope of the invention. The invention resides in the novel airflow path configurations and therapeutic applications, not in the particular mechanical means of adjustment.

### BRIEF DESCRIPTION OF THE SEVERAL VIEWS OF THE DRAWINGS

FIG. 1 is an exploded perspective view of an embodiment of the complete SOVT device showing, from proximal to distal, a mouthpiece cap 10, proximal gasket 12, rigid tube 20 with vent apertures 22a-22c, removable helical insert 30, flexible oscillatory membrane 42, distal plug body 40, distal end cap 50, and knurled adjustment collar 48.

FIG. 1A is an enlarged exploded perspective of the distal plug sub-assembly of FIG. 1, illustrating the flexible oscillatory membrane 42, distal plug body 40, threaded post 44, sleeve for threaded post 46, distal end cap 50, and knurled adjustment collar 48.

FIG. 2 is a longitudinal cross-section of the assembled device of a non-oscillatory variant embodiment of FIG. 1, illustrating airflow (arrows) entering at the mouthpiece 10, following a helical path defined by insert 30 within tube 20, reversing at the indentation of distal plug 40, and directing back toward the proximal end of the device toward vent apertures 22a-22c (shown in FIG. 2A).

FIG. 2A is longitudinal cross-section of the assembled device of FIG. 2 along the A axis, illustrating airflow (arrows) entering at the mouthpiece 10, following a helical path defined by insert 30 within tube 20, reversing at the indentation of distal plug 40, and exiting proximally through apertures 22c, 22b, and 22a.

FIG. 2B is longitudinal cross-section of a variant embodiment of the assembled device of FIG. 2 along the A axis, illustrating airflow (arrows) entering at the mouthpiece 10, following a helical path defined by the smooth side 30a of insert 30 and peripheral sealing rib gasket 32 within tube 20, reversing at distal plug 40, and exiting proximally in a helical path defined by dimple-textured side 30b of insert 30, through vent apertures 22c, 22d, and 22a. A ring 38 for holding and stabilizing the device, and a proximal end air seal 31 integrally formed as part of insert 30 directing airflow to vent aperture 22a, are shown in situ.

FIG. 3 is an exploded perspective view of an embodiment of the complete SOVT device showing, from proximal to distal, a mouthpiece cap 10, proximal gasket 12, rigid tube 20 with vent apertures 22a-22c, removable helical insert 30, distal vent aperture 22e, distal plug body 40, and distal end cap 50.

FIG. 3A is an exploded perspective view of a unidirectional helical path embodiment showing, from proximal to distal: mouthpiece cap 10, proximal gasket 12, rigid tube 20 without side vent apertures, tight-pitch helical insert 30 providing extended airflow path length, distal plug body 40 with central aperture 22e, distal end cap 50, rotating orifice selector disc 47 having graduated apertures from 2-8 mm diameter, O-ring seal (not numbered), and knurled adjustment collar 48. Arrow indicates rotational adjustment direction.

FIG. 3B is an exploded perspective view of a two-component embodiment showing: integrated mouthpiece/gasket assembly 11/13, and multi-function helical insert 33 comprising central airflow column, peripheral sealing rib 32 defining return path, distal transfer port 35 connecting central column to peripheral path, and integrated distal plug 34. Rigid tube 20 has diamond-shaped vent apertures 22a-22c. Threaded distal closure 40 with threads 45 and end cap 50 provide sealed termination.

FIG. 4 is an exploded perspective view of a central flutter valve embodiment showing, from proximal to distal: mouthpiece 10, flutter valve element 60 configured as a flexible cone for oscillatory resistance, helical insert 30 with central channel accommodating the flutter element, rigid tube 20 with vent apertures 22a-22c, and threaded distal cap 40. The flutter element extends through the helical insert core to create oscillatory resistance within the primary airflow path.

FIG. 5 is an exploded perspective view of a nebulizer adapter assembly showing: SOVT device mouthpiece 10 and mask 105 (which may be a standard medical device mask); either of which may connect to adapter housing 70 at port 24c; adapter housing ports 24a and 24b, with corresponding inlet and outlet check valves (position indicated by dotted lines 25a and 24b, demonstrating that the valves are integrated in housing 70); optional side air inlet 23a for mixing ambient oxygen in breathed air and for allowing nebulizer mist exit when check valve 25a is closed; rigid tube 20; distal plug body 40; distal end cap 50; and knurled adjustment collar 48. An oval-to-round transition adapter 71 mates the oval cross-section of tube 20 to the circular inlet of nebulizer adapter housing 70, ensuring an airtight interface. The ports enable medication-laden air from the nebulizer 101 to enter through 24a while expiratory flow exits through the 24b, maintaining therapeutic resistance while delivering aerosolized medications.

(Note: The drawings are intended to illustrate the principles and embodiments of the invention. They are not necessarily drawn to scale, and like reference numerals indicate corresponding parts throughout the figures.)

### DETAILED DESCRIPTION OF THE INVENTION

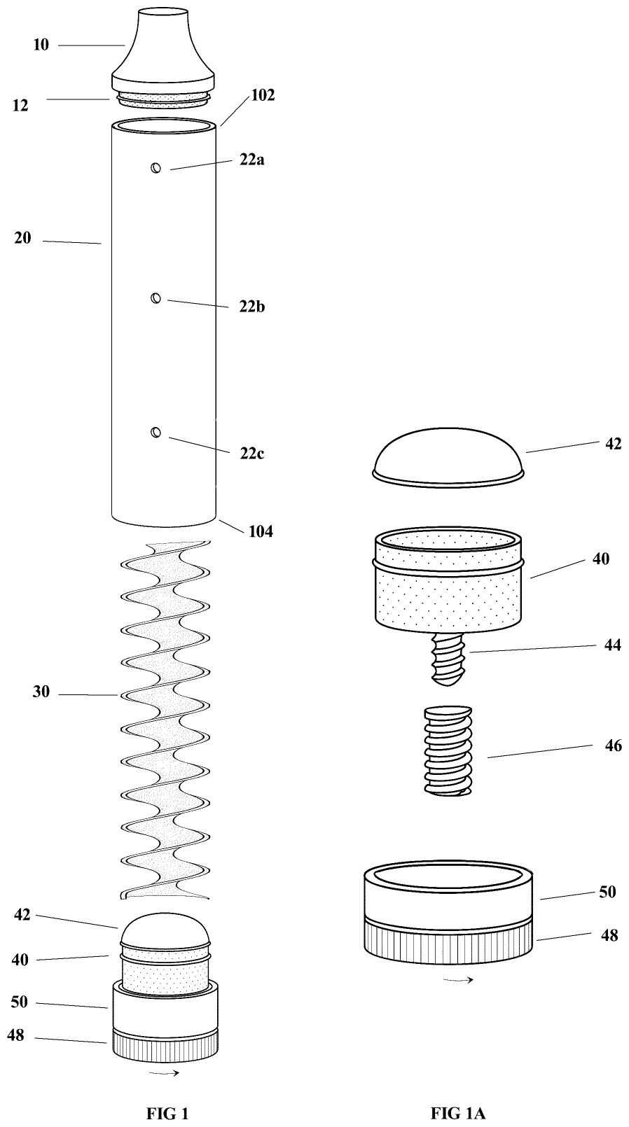

Referring now to the drawings, wherein like numerals indicate like elements, FIG. 1 shows a preferred embodiment of the semi-occluded vocal tract exercise device in an exploded view. The device includes a main tubular body 20 and a removable helical insert 30. The helical structure may take various geometric forms while achieving the core function of creating a tortuous airflow path. For nonlimiting examples, the insert may comprise a single coiled element (creating an air flow path similar to a spring), a helical ribbon or blade (creating an air flow path similar to an auger), a double-helix (creating an air flow path similar to DNA) or even multiple intertwined helical elements. The specific helical geometry may be selected based on manufacturing preferences, desired resistance characteristics, or ease of cleaning, with all variations providing the benefit of increased effective path length within a compact device envelope. The main body 20 is an elongated rigid tube defining an internal lumen. In the depicted embodiment, the tube 20 has an oval cross-sectional shape and is made of a rigid, durable material such as stainless steel. The tube 20 has a proximal end 102 (which the user places at or in the mouth) and a distal end 104 (which in this design remains closed by the distal plug assembly comprising elements 42, 40, and 48). The inner surface of tube 20 is smooth and sized to closely accommodate the insert 30. An outer wall of the tube includes one or more vent apertures 22, described in detail later, which communicate between the interior lumen and the outside environment.

The insert 30 is a core component that defines the tortuous airflow path within the device. In FIG. 1, insert 30 is shown aligned for insertion into the tube 20. The insert 30 in this embodiment is a one-piece molded helicoid made of a slightly flexible material (preferably medical-grade and/or food-safe silicone). It has a generally spiral or corkscrew form factor, resembling a twisted fin or ribbon. The insert's cross-section matches the oval interior of the tube so that it can only be inserted in the correct orientation. Running along the entire outer edge of the insert 30 is a peripheral sealing rib acting as the point of contact with tube 20. This rib may be a raised ridge of material, or a continuation of the insert's form, configured such that it presses against the inner wall of tube 20 when the insert is in place, creating a seal. The rib may be continuous (forming a spiraling flange) or segmented, or both within one device, and it ensures that there are essentially two separate channels within the tube: one on each side of the insert partition.

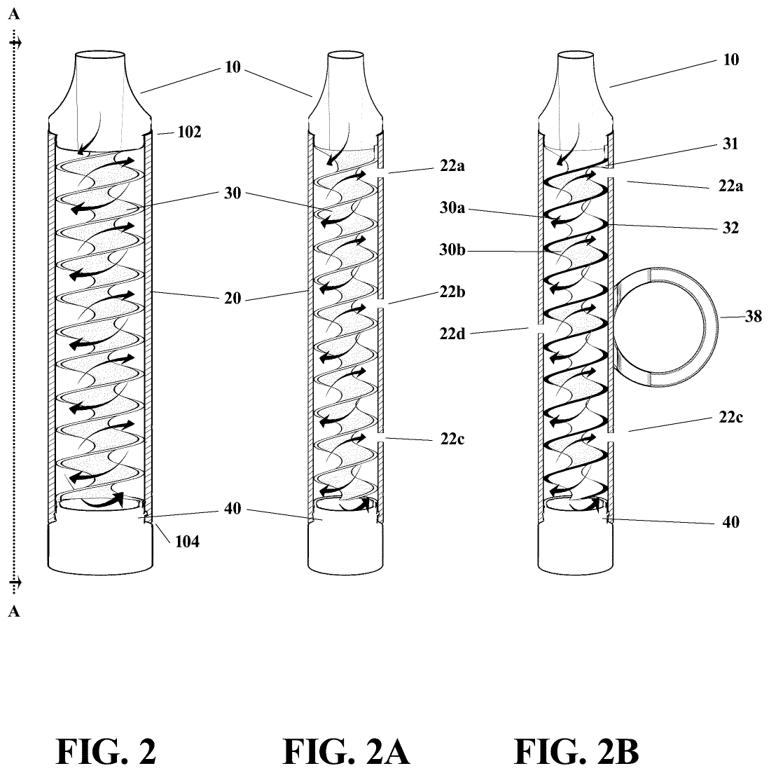

As best seen in FIG. 2, FIG. 2A, and FIG. 2B, when the insert 30 is installed inside the tube 20, it effectively divides the tube's central lumen into a dual-path helical channel. FIG. 2 is a longitudinal section cut through the assembly along Axis A, revealing the airflow route. The helical insert 30 acts as a partition that forces air to travel in a corkscrew fashion. Specifically, as indicated by the directional arrows, the space on one side of the guides air from the proximal end 102 down toward the distal end. Upon reaching the distal end of the device, the space on the opposite side of the spiral carries the air back up toward the proximal region. The two channel portions are isolated from each other by the insert 30 itself (with integrated sealing rib ensuring no cross-leakage along the edges). In this manner, any air entering the device is constrained to follow the insert's geometry moving down and up along a swirled U-shaped path inside the tube rather than straight through.

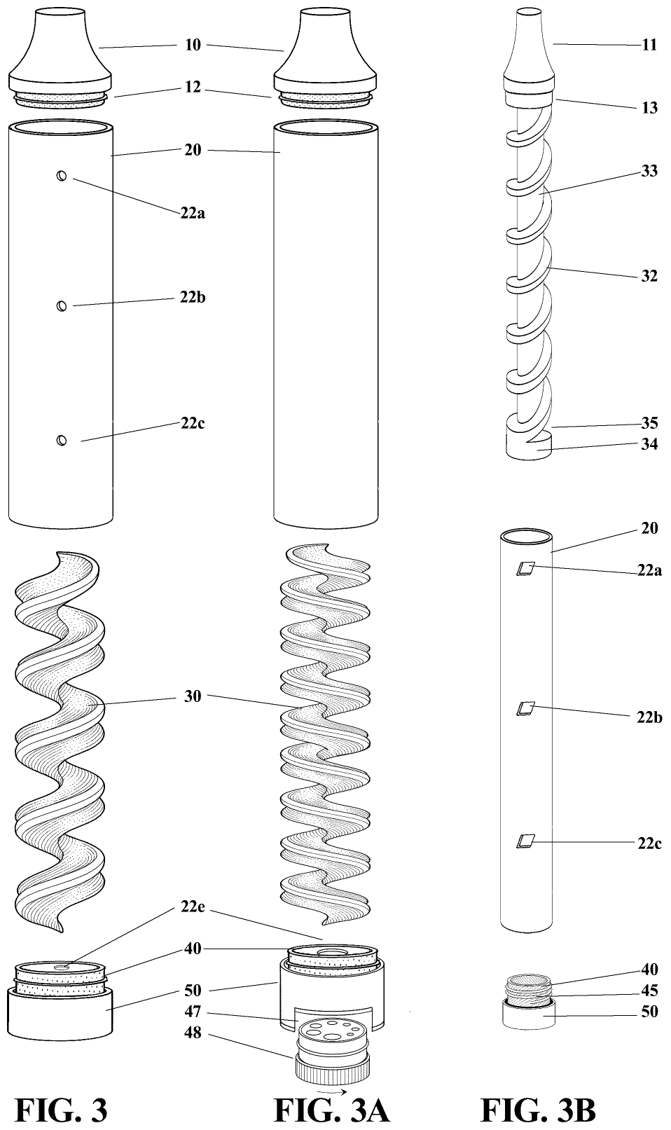

To complete this U-shaped path, the distal end of the device features an integrated or additional end cap or plug assembly. Such a distal end cap or plug assembly is sized to fit securely at the distal opening of tube 20, thereby occluding the distal end 104 of the tube. In the illustrated embodiment of FIG. 3B, distal plug 34 is a somewhat disk-shaped enlargement at the bottom of the insert, which seats tightly against the internal wall of the tube (and optionally flush with the tube's end) to block airflow from simply exiting the tube's bottom. A distal plug may be an integral part of the silicone insert as in FIG. 3B, or a separate piece affixed to the insert. When the insert 30 is fully inserted, plug 34 effectively becomes the new “bottom” of the airflow passage: air reaching this point cannot exit straight out, and instead is redirected. Optionally, the distal plug and/or distal plug assembly comprises a concave shape to facilitate airflow. Optionally, the distal plug and/or distal plug assembly comprises a hole for airflow release, and optionally further comprises a pressure release valve which may be configured to be adjustable. As shown by the curved arrows in FIG. 2, FIG. 2A, and FIG. 2B, upon hitting the closed distal end, the air flows around the bottom edge of insert 30's spiral partition and reverses course into the ascending channel defined by the other side of the insert. It then travels upward through the tube, on the opposite side of the insert from which it descended. In this manner, the device forces exhaled air to traverse at least the full length of the tube internally (down) before it can escape at a selected point along the upward path, dramatically increasing lengthening the user's effective vocal tract; this ensures a lengthening of the user's vocal tract beyond what would be the case in a device which allowed exit at a path prior to the distal end of the device, as would be the case but for the path defined by insert 30. In preferred embodiments a user's airflow will not have an opportunity to escape the device until it has traveled on an extended helical path at least to the distal end of the device and back upward to the first encountered air vent on the doubled-back path.

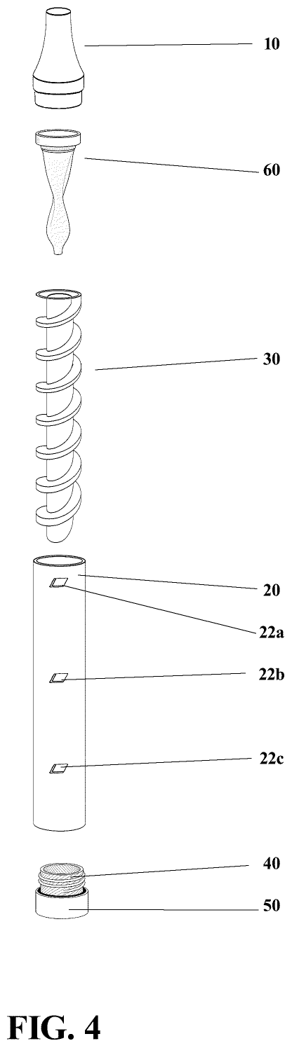

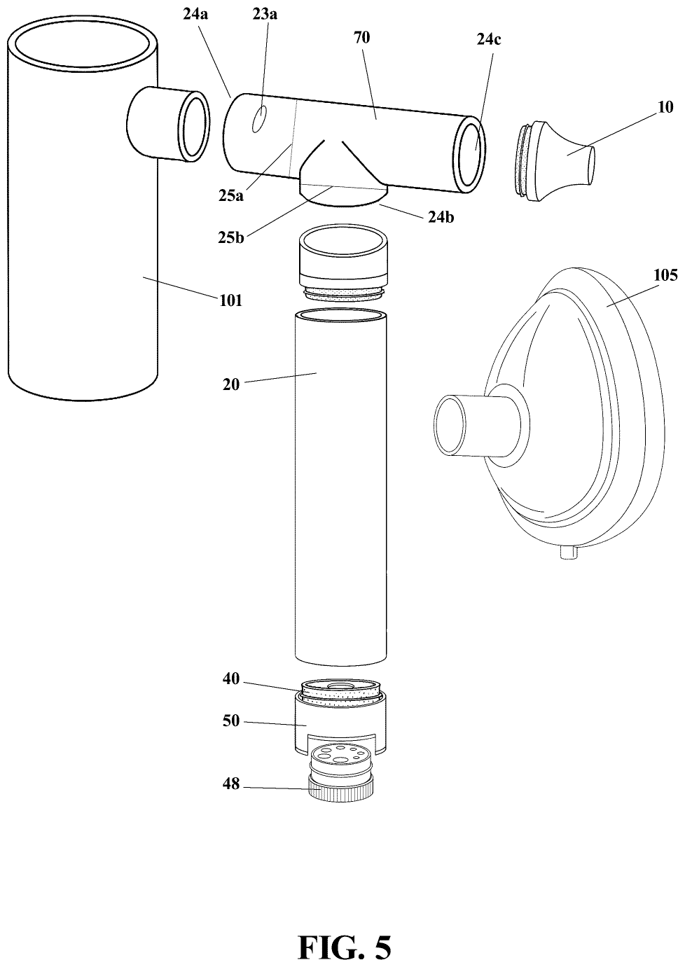

In an alternative embodiment, the helical airflow path extends unidirectionally from the proximal end to the distal end without requiring airflow reversal. In this configuration, the helical insert or integral helical channel guides air in a single spiral from the mouthpiece directly to the distal opening, maximizing the effective acoustic path length within the device's physical constraints. An adjustable resistance element, such as a ball valve, iris valve, needle valve, or other element with variable aperture, is positioned at the distal end to provide precise control over airflow restriction. This single-path helical design can achieve the maximum possible path elongation within a given tube length while maintaining the semi-occluded vocal tract benefits through end-point resistance modulation. In certain embodiments such as the embodiment of FIG. 3A, the device may omit side vent apertures entirely and instead use an adjustable end-piece to set the resistance. Such an adjustable resistance element may comprise a rotating disc valve having a plurality of apertures of varying diameters, wherein rotation of the disc aligns different apertures with the airflow path to provide discrete resistance settings. Alternative implementations may comprise sliding aperture plates, conical needle valves, or medical-grade stopcocks, all sharing the common feature of providing user-adjustable flow restriction at the distal terminus. Preferred embodiments which comprise an adjustable resistance element will maintain an ease of maintenance, and the adjustable resistance element may comprise antimicrobial materials. It is also contemplated that a user may find benefit in an embodiment of the device which does not comprise a tortuous path. For nonlimiting example, in FIG. 4, a user may desire to insert Heimlich valve 60 into tube 20, and forego use of insert 30. The user may desire to further forego the Heimlich valve and use only tube 20 and a variable resistance distal plug assembly such as that displayed in FIG. 3A.

In certain embodiments, the adjustable resistance element may comprise a spring-loaded poppet valve wherein a biocompatible elastomeric disc is biased against a valve seat by an adjustable compression spring. External rotation of the adjustment collar varies spring preload, thereby modulating the opening pressure threshold. The valve geometry may permit bidirectional flow while preventing accumulation of moisture or debris.

In certain preferred embodiments, the resistance element comprises a rotating orifice selector disc having a plurality of graduated apertures arranged circumferentially, as in FIG. 3A. The disc is retained against the device body by circumferential O-ring seal, permitting rotation while maintaining airtight closure. Aperture diameters may range from 2 mm to 8 mm, providing resistance settings validated in predicate respiratory training devices. (It is contemplated that ranges outside this level may be provided without straying from the invention. For nonlimiting example, in therapeutic settings, a clinician may desire a wider air vent in order to both take advantage of the tortuous path defined by the insert and be able to see visible feedback of bubbles by requesting a patient to blow bubbles in a cup of water.) The orifice selector disc may include tactile or audible detents at each aperture position, providing positive feedback for resistance selection even when the device is at the user's mouth.

Although a removable insert is preferred for ease of cleaning and interchangeability, in certain embodiments the helical airflow path is formed integrally with the tubular body itself. For example, the inner wall of the tube may be molded, machined, or 3-D-printed with an internal helical baffle or groove so that the tortuous passage is permanently fixed. Whether removable or integral, the operative requirement is creation of a non-linear path that increases effective path length while preserving the device's compact external dimensions.

It is further contemplated that in certain embodiments, tube 20 may have an interior wall which is not smooth, for example in order to lessen a whistling effect caused by aligned airflow passing over a vent hole 22. In certain embodiments, the interior wall of tube 20 may comprise grooves or other means of aligning and/or securing an insert into a proper position. In certain embodiments, the interior wall of tube 20 may comprise an elastomeric and/or compressible material configured to accept an insert with enough friction to provide adequate delineation and/or separation of the air column. For nonlimiting example, tube 20 may comprise a rigid carbon fiber exterior wall and a silicone interior wall, and insert 30 may be formed from a solid piece of stainless steel or brass configured to fit snugly against the silicone interior tube wall.

It is contemplated that in certain embodiments such as the embodiment shown in FIG. 3B, the insert may comprise an integrated mouthpiece 11. It is further contemplated that the insert may comprise an integrated distal end such as integrated distal end 34. A distal end may comprise one or more distal holes to put the air channel in communication with the air outside of the device.

It is contemplated that in certain embodiments, the device may be equipped with electronic pressure measuring equipment which may sync with a computer device for reading and displaying measurements. It is contemplated that in certain embodiments, the insert and/or other surfaces along the path of air may be dimpled or otherwise made to have a surface texture that is non-smooth and/or non-uniform in order to make the device quieter while user breath flows through. This may be particularly helpful in lowering alignment of airflow and consequent airflow turbulence to prevent a whistling noise when air escapes through vent holes. This texturing may be beneficial as an added feature for embodiments of prior disclosures in this patent family as well.

The advantages of this device's configurations are significant for vocal training. By increasing the path length and confining the air in a narrow channel, the device raises the back-pressure delivered to the user's vocal tract and does so in a way which some users have perceived as more comfortable when compared to simple constriction of airflow in predicate devices, due to the compressible nature of air. This helps keep the vocal folds slightly adducted and optimally resistant as the user phonates, encouraging efficient vibration. The helical channel also introduces a form of turbulence or rotational airflow component, which might further enhance the respiratory muscle engagement (though the primary benefit is from the extended length and constricted airflow exit leading to the resulting elevated inertance). Because the insert 30 is removable, the user can easily clean out any condensation or particulate buildup in the channel after use, which is important for hygiene given that moisture from breath will collect along the channel walls. The insert can be removed by simply pushing it out from the tube (or pull it out in the case that it is configured to protrude from the tube on the proximal or distal end, and/or has an integrated eyehole or bail to facilitate wearing) to extract it for cleaning.

Turning to FIG. 3 and FIG. 3A, additional variations of the insert 30 are illustrated. In these exploded views, the airflow path formed by the insert is unidirectional (proximal to distal): the insert has a spiral form like a corkscrew rather than the DNA-like twist of FIG. 2. The exact number of helical turns can vary (e.g. some embodiments might have a quarter-turn twist, others could have multiple turns if the tube is longer or the helix tighter). In certain embodiments, the distal plug assembly (whether integral to insert 30 or separate) comprises an eyelet, essentially a small loop or hole through which a cord could be passed. The presence of an eyelet allows the entire assembled device to double as a pendant or keychain fob. A vocalist could, for example, thread a necklace chain or lanyard through the eyelet and wear the device around the neck, ensuring it is always within reach for a quick warm-up exercise. The eyelet is merely one example of a suspension element; in alternative embodiments, a metal ring or bail could be attached directly to the tube 20 instead (for instance, soldered onto the tube's outer surface) to serve a similar purpose. In another alternative embodiment, a clip, bail, or necklace/ring securement may be fitted as a component sitting between tube 20 and mouthpiece 10. Whether on the insert or on the tube or as another component part, such a suspension feature is optional and may be included or omitted based on user or producer preference. It is contemplated that in certain unidirectional (proximal to distal) embodiments, a deformable element or elements may be positioned at the distal end of the tube; it may be configured to allow for air to pass through in pulses on its path to a distal vent.

It should be noted that the materials for the insert 30 can be varied. Silicone (or other biocompatible elastomers like thermoplastic elastomers) is preferred in many cases due to its flexibility, seal-forming ability, and ease of molding complex shapes like the helicoid and rib. Silicone inserts also make the device more comfortable if the user's lips contact the insert at the proximal end (though typically the lips grip the tube's rim). However, in some embodiments the insert 30 may be made partially or entirely of rigid materials. For instance, certain variants use a rigid metallic helicoid insert with an elastomeric coating or gaskets 32 along its edges (as schematically shown in FIG. 2B). In such a design, the main spiral body could be metal (such as brass or stainless steel) for durability and for maintaining a precise shape, while the edge gaskets 32 (e.g., silicone strips or rings) ensure an airtight fit in the tube. The metal insert might be machined or stamped in the form of a spiral fin, and the gaskets could be snap-fitted or bonded to its periphery. Another variant (also mentioned above) is a composite insert assembly comprising an inner sleeve that lines the tube's interior. This sleeve could be made of silicone or rubber and contain a built-in spiral partition defining the two channels. A supporting metal core (e.g., a steel spring or frame) can be embedded in or inserted into the sleeve to prevent collapse and maintain alignment. In effect, the entire interior of tube 20 could be a removable liner (sleeve) that contains the helical pathway, with the metal core adding stiffness. Such an arrangement might simplify cleaning (one can remove the whole liner and rinse it) and allow for disposable or replaceable inserts with different resistance profiles. Further, these and other variations may be desirable to allow for more variation of styles and materials. For example, the exterior of tube 20 may be molded into or formed to accommodate a different exterior shape or appearance for marketing purposes (e.g. as a microphone for singers) or to appeal to a demographic (e.g. a toy-like plastic animal for children's therapy; lacquered wood or carbon fiber for upscale feel) and enhance retail value or frequency of use.

The versatility of the helical insert system extends to specialized configurations optimized for specific user populations and therapeutic applications. For respiratory therapy applications, inserts can be configured with graduated resistance profiles that accommodate the limited lung capacity of COPD patients while still providing beneficial expiratory muscle training. These therapeutic inserts may incorporate pressure relief features (e.g. a configurable vent in a distal plug) that prevent excessive back-pressure buildup that could be contraindicated for certain pulmonary conditions. For instrumental music education, inserts can be designed with resistance characteristics that simulate the back-pressure profiles of specific woodwind or brass instruments, allowing students to develop proper breath support before progressing to their actual instruments, and/or to allow students to practice breath support discreetly and quietly. Inserts may have visual indicators such as different colors indicating different resistance levels that will help instructors communicate breath support concepts effectively. For professional vocal training, inserts can be optimized for specific vocal techniques such as belting, classical technique, or contemporary commercial music styles, with resistance curves that promote the muscular coordination patterns associated with each approach.

Now focusing on the adjustable venting features of the device, reference is made to FIG. 2A. The main tube 20 is shown with three representative vent holes 22a, 22b, and 22c in its side wall. (In practice, there may be one, two, three or more such holes spaced along the length. In preferred embodiments, the vent holes will be configured along the length of the device to accept finger covering when the device is grasped in one hand in a natural fashion by a user, e.g. with no more than 4 vent holes on one side of the device, i.e. for the fingers; and no more than one hole on the other side of the device, i.e. for the thumb.) In the illustrated example of FIG. 2A, one vent hole 22a is located nearer to the proximal end, one vent hole 22b is located in the middle of the device, and one vent hole 22c is located nearer to the distal end. Each vent hole passes through the tube wall and opens into the space of the internal channel. Depending on the rotational orientation of the insert 30, a given vent hole will intersect either the descending portion or ascending portion of the airflow path. Thus, given the advantages of a extending a user's vocal tract, in preferred embodiments the correct rotational orientation will be apparent to the user. This may be accomplished by color coding, labeling, notching tube 20 and matching a protrusion of insert 30, or any other appropriate means. In an embodiment such as FIG. 2B where the tube is oval and the insert is thus keyed to a fixed orientation, the vent placement can be planned such that, for instance, no air exits in the downward path. Perhaps a vent 22d is configured at the middle position of the tube opens into the midpoint of the ascending airflow channel. If that vent is uncovered (in this embodiment, by the user's thumb), air traveling upward will escape through it once it reaches that point, instead of continuing further upward toward 22a. By strategic placement of multiple vents on different sides or positions, the designer can provide a range of effective path lengths selectable by the user. However, even a single vent hole provides utility: the user can choose to keep it open (lower resistance, as air will vent early) or closed (higher resistance, full path used) or even partially covered to fine-tune the resistance. It is contemplated that in various embodiments, a designer may use vent holes of uniform or varied diameters/cross-sectional area. It is contemplated that in various embodiments, a designer may position an adjustable valve on the wall of tube 20, for nonlimiting example at the location of 22a in FIG. 2A, which would position it near the end of a bidirectional (down and up) tortuous airway path, to enable the longest airway path. In such an embodiment, it may be desirable to forego inclusion of other vent holes such as 22b and 22c.

Turning to FIG. 1: In particularly advantageous embodiments, the invention incorporates a deformable oscillatory element 42 which may be integrated into the distal plug assembly to create controlled mechanical oscillation without moving parts. Such embodiments utilize a double helical insert (or, in more simple embodiments, a dividing wall insert which may or may not comprise a twist) defining two airflow paths (e.g. down and up) that converge at the distal terminus. In FIG. 1, the deformable element 42 is integrated with a twist-adjustable distal plug assembly detailed in the exploded view of FIG. 1A, which interfaces the deformable element with the helical airflow paths of FIG. 1 to generate oscillatory resistance.

In preferred embodiments comprising a deformable element, said deformable element may itself comprise a flexible membrane or bladder enclosing a compressible medium such as air, medical-grade silicone gel, or elastomeric material. Such a membrane or bladder is optimal for ease of cleaning. (It is contemplated that in certain embodiments with a deformable element there may be no external membrane encasing the compressible medium. Such may be the case with dense gelatinous materials such as ballistic gel.) This element is positioned within the distal plug or in between the insert and the distal plug, configured to interface directly with the distal terminus of the double helical airflow paths. Under expiratory pressure, the airflow from the helical path from the proximal end creates sufficient force to deform the flexible element past a threshold pressure which will allow air to escape around, past, or through the deformed area and into the helical path back upward toward the mouthpiece (and air vent holes). As pressure drops following air release, the deformable element recovers to its original shape, re-establishing flow restriction and initiating the next oscillation cycle.

While in FIG. 1 and FIG. 1A, deformable element 42 is displayed in a bubble shape which is considered to be optimal, it is contemplated that the deformable element may be configured in other shapes as well, including but not limited to flat-topped or concave. It is contemplated that the deformable element may comprise a slit configured such that the element deforms away from itself and back into itself to allow passage of air, and that there may be multiple deformable elements configured to accomplish the passage of air. It is contemplated that a deformable element may be configured along the length of the tube between the insert and wall of tube 20, such that oscillation of air pressure occurs at a location that is not the distal end.

In certain embodiments, such as that of FIG. 1 and detailed in FIG. 1A, the distal adjustment mechanism operates similarly to pharmaceutical stick applicators, utilizing a twist-actuated advancement system wherein rotation of an outer sleeve or collar causes linear advancement or retraction of the deformable element via helical threading or cam action. This mechanism enables precise control over the contact pressure between the deformable element and the helical insert terminus, thereby modulating oscillation frequency, amplitude, and intensity according to therapeutic requirements. The adjustment mechanism may transition smoothly in advancement or retraction, and it may have measured intervals which may be configured to be more defined than others, such that the desired resistance may be set.

In certain embodiments, the deformable element is removable and replaceable, allowing customization of oscillation characteristics through selection of different compressible media, membrane materials, or element geometries. For example, an air-filled element may provide rapid recovery and higher-frequency oscillation, while a gel or gel-filled element offers more controlled, lower-frequency oscillation with enhanced tactile feedback. It is contemplated that in various embodiments the deformable element may be stationary and/or not adjustable, and may be integral to the device or modular. It is further contemplated that in certain embodiments, the deformable element may be configured such that it is able to click into place and out of place in a similar way to a pen clicking in to extrude the pen tip and clicking out to retract the pen tip.

In certain oscillatory embodiments, the distal resistance element comprises a weighted ball valve seated in a conical chamber, wherein expiratory pressure periodically lifts the ball to create flutter characteristics. The ball may comprise a steel core with elastomeric overmolding, enabling tuning of oscillation frequency through material selection and ball mass. The conical seat angle and ball diameter are selected to achieve therapeutic oscillation frequencies optimal for airway clearance and vocal fold massage. Such a resistant element could also be positioned near the proximal end of the device at the beginning of airflow, either incorporated as part of the mouthpiece or as a modular component between the device's tube and the device's mouthpiece. (It is contemplated that in certain embodiments the device may be modular, and connections may be made to extend the device's length and feature set.)

A flutter valve embodiment is shown in FIG. 4. Here, a thin flexible membrane Heimlich valve 60 is a component of the whole device so that it fits into the tube's proximal hole. In operation, when the user exhales into the device, pressure builds in the internal channel. At a certain point, the pressure differential across membrane forces it to bend outward, briefly opening the vent at the distal end of the membrane and releasing a burst of air. As the air and pressure drop, the membrane snaps back to its resting position, closing the vent again. This cycle can repeat many times per second, creating a rapid flutter or vibration. The result is that instead of a steady flow, the vent leaks air in a pulsating manner. From the user's perspective, this introduces an audible fluttering sound and a vibratory sensation. The oscillation frequency depends on factors such as membrane stiffness, tension, hole size, and airflow rate, but can be tuned to fall within a range comfortable and therapeutic for the vocal tract (for instance, a few to a few hundred pulses per second). The device can include one or more such flutter-equipped vents. In some embodiments, the membrane could be a small silicone disc or a flap that is part of a replaceable module. Alternatively, a lightweight mechanical one-way valve (like a reed or a flapper made of Mylar or thin metal) could achieve a similar effect, though adding moving parts. The flutter feature is optional and can be enabled or disabled by the user (for example, by switching out a solid plug for a flutter plug, or by rotating a cover that either holds the membrane in place or frees it). When engaged, the flutter vent provides a dynamic resistance profile. That is, the back-pressure is not constant but rather oscillates. This is intended to further engage and strengthen the vocal support muscles and perhaps simulate a gentle “massage” on the vocal folds during phonation training. It may be also desirable in respiratory therapy applications.

For therapeutic applications, the flutter valve can be tuned to oscillate at frequencies suitable for vocal training and respiratory therapy applications. Effective tuning can be achieved by selecting appropriate vent aperture sizes and membrane materials and thickness. Adjusting membrane tension or thickness allows users to customize the onset pressure and flutter characteristics for individual preferences and therapeutic goals.

In the particularly advantageous embodiment of FIG. 4, a centrally-positioned flutter mechanism 60 extends longitudinally through the helical channel, resembling a Heimlich valve configuration. This central flutter element comprises a lightweight, biocompatible membrane or reed that deflects rhythmically under expiratory pressure, creating oscillatory resistance directly within the primary airflow path. The central positioning provides several benefits: the oscillations propagate through the entire helical channel for maximum therapeutic effect, the element is easily replaceable for different flutter characteristics, and the design maintains easy cleaning access despite the complex internal geometry. In certain embodiments, the airflow path may first coil around a centrally positioned channel from the proximal toward the distal end, at which point said airflow path may reverse direction and travel from the distal end toward the proximal end along a separate path of coiling until such point as it reaches an inlet to said centrally positioned channel, at which point it may again reverse direction and flow through said centrally positioned channel toward the distal end. The air exit may be only at the distal end, optionally through a valve configured varies resistance. There may also be air exits along the length of the tube, which may optionally be configured to be put in communication with the centrally positioned channel through a pathway-defining insert or with one or more of the coils of airflow around the centrally positioned channel. Some such embodiments may comprise a flutter valve (e.g. Heimlich valve) inside said centrally positioned channel. In this way, the length of airflow may be maximalized prior to passing through the flutter valve.

Throughout this detailed description, various embodiments and alternatives have been presented. It should be understood that these are not mutually exclusive—the inventive device can be configured in many combinations of the disclosed features. For example, an embodiment could have the helicoid insert with sealing rib and also include multiple vent holes with both plug closures and one flutter valve on the lowest hole. Another embodiment might choose a simpler approach with only a single vent hole and no flutter, but use a metal insert with a gasket for extreme durability. In certain embodiments, the tube 20 need not be oval; for nonlimiting example, it could be circular and optionally comprise an internal keying mechanism (such as a groove and spline) to align the insert properly. In other embodiments, the spiral path could be accomplished with two or more separate insert pieces (for instance, stacking rings or baffle discs that create a labyrinth). In other embodiments the airflow path may be tortuous but not helical; for example the airflow path may be primarily planar arranged to wind nonlinearly and expand the effective length of said airflow path. In such embodiments and others it is contemplated that the “tube” may be replaced with some other encasement, which may be modular for ease of cleaning.

The materials listed are likewise able to be varied: metals with antimicrobial properties are preferred for the tube (e.g., brass, copper, copper-electroplated steel) and/or insert, but strong polymers could also be used for a lightweight version. Material selection considerations extend beyond basic biocompatibility to include specific therapeutic and performance characteristics. For medical applications, materials must meet FDA requirements for repeated oral contact and be compatible with common disinfection protocols used in clinical settings. Antimicrobial materials such as copper alloys or silver-impregnated polymers provide inherent pathogen resistance particularly valuable in institutional settings where cross-contamination prevention is critical. For educational applications where devices may be shared among multiple students, materials with enhanced durability and rapid cleaning capabilities are preferred. The helical insert materials can be selected for specific acoustic properties, with certain elastomers providing damping characteristics that reduce unwanted resonances while metallic inserts may be chosen to enhance acoustic feedback for users who benefit from auditory training cues. Surface texturing of insert materials can be optimized to promote specific airflow characteristics, with smooth surfaces minimizing turbulence for users requiring gentle resistance, while textured surfaces can be employed to enhance the oscillatory effects desired for advanced training applications. The insert is preferably elastomeric for a good seal, but could be a hard plastic with gaskets. Such variations that leverage the core concept of a removable internal partition creating a tortuous, resistive airflow path fall within the scope of the invention.

Operation of the device: To use the device, a user places the proximal end of tube 20 or mouthpiece 10 between their lips, forming a seal. (Optionally, the device is configured to allow a facemask to be worn which would direct airflow into the proximal end of the tube.) The user then exhales and/or phonates (sustains a voiced tone) into the device. The exhaled air is forced to travel through the device's internal helical channel as described. This creates an elevated air pressure in the mouth and pharynx (back pressure against the vocal folds) which helps the vocal folds vibrate with reduced collision force and improved efficiency. The user can adjust the resistance by choosing which vent holes 22 are open. For maximum resistance and inertive effect, all vent holes except possibly the uppermost are kept closed, so that air must traverse the full length of the spiral channel and only escapes near the top of the device. If the user feels too much pressure or wishes to reduce the load, they can uncover a vent (for example, lifting their finger off a hole) to allow greater exit opportunity for the air, thus reducing back-pressure. In embodiments with a flutter valve or deforming oscillatory element, the user will experience a vibrating sensation as they blow, which can be both auditory (a fluttering sound) and tactile. This oscillation can be very useful in loosening tension and encouraging a relaxed, resilient phonation. The device may be used in various postures (upright, tilted, etc.), and thanks to its sealed design, it does not require water or any external medium (unlike certain prior art devices that involve bubbling air through water for resistance). When finished, the user can easily clean the device by removing the insert 30 from the tube and rinsing both parts. The materials (steel and silicone, for example) can be washed with soap and water or mild disinfectants without degradation. The antimicrobial nature of preferred tube materials further ensures that germs do not proliferate on its surface between uses.

Clinical and educational protocols for device usage vary significantly based on the intended application and user population. For speech-language pathology applications, the device enables precise titration of expiratory resistance to match specific therapeutic goals such as vocal fold strengthening, breath support improvement, or reduction of hyperfunctional vocal behaviors. Therapists can systematically progress patients through resistance levels by modifying vent aperture configurations or substituting helical inserts with different geometric parameters. The oscillatory features provided by flutter valve embodiments can be particularly beneficial for patients with muscle tension dysphonia and other maladies, as the vibratory feedback helps interrupt maladaptive muscular patterns while promoting more efficient vocal fold oscillation. For instrumental music education, the device serves as a breath training tool that can be integrated into warm-up routines, technical exercises, or remedial instruction for students experiencing breath support difficulties. Band directors can utilize the device to demonstrate proper breath pressure concepts before students attempt similar techniques on their instruments, reducing the learning curve associated with embouchure development and breath management. The modular nature of the system allows educational institutions to maintain device inventories that serve multiple instrument families while accommodating students of varying skill levels and physical development.

In certain embodiments the apparatus can be adapted for professional coaches, referees, and on-field directors who routinely carry a whistle. In such a version the proximal mouthpiece is configured to accept a removable whistle module that nests seamlessly between the mouthpiece cap 10 and the rigid tube 20, or operate as a replacement for mouthpiece cap 10. While the whistle signal may be achieved by any appropriate means, in certain preferred embodiments, the whistle module may employ a pea-less chamber and may be configured so that it can be silenced or bypassed instantly: a user may rotate the module to an “open-air” position that aligns a straight bore with the helical airflow path for vocal-tract exercise, or twist (or press, or flip a cover) to place the whistle cavity in series with the airflow for standard audible signaling. When the whistle is in its signaling position the helical insert 30 and adjustable vent 22a-22c remain downstream, allowing the same device to serve as an immediate vocal therapy tool during breaks in play. The outer housing may incorporate a low-profile hanger loop or a polished metal clip so the unit can be worn on a standard lanyard or clipped to a suit lapel, matching the aesthetics of professional sideline attire while discreetly embedding therapeutic function that addresses the chronic vocal-strain issues common among coaches and referees. Because the whistle module is detachable, it can be removed entirely for cleaning or replaced with a solid cap, enabling hygienic sharing of the core device among multiple users without compromising whistle acoustics or vocal-training efficacy. It is contemplated that such a mechanism may be incorporated into devices as disclosed in parent filings of the present disclosure.

Various practitioners of SOVT prefer various specific lengths and diameters of straw for their own practice and that of their clients and students. As such, the following discussion is provided. It is meant to be exemplary and not limiting. It has been demonstrated in studies that using a narrow diameter (e.g. 2 mm-5 mm) straw is effective for achieving many of the key SOVT benefits, and that especially in diameters such as this, the length of the straw is not nearly as important as the diameter of the straw in a user feeling a difference in effect. Even short distances like 80 mm or lower are able to achieve desired effects. It's further been demonstrated that there are benefits to be gained through the use of wider straws at significantly longer airway lengths. An example of this is the “Finnish Resonance Tube” which uses a wider straw at a length closer to 30 cm, optionally submerged in water to induce bubbles of cycling airflow resistance. But carrying a long tube, even a flexible tube, can be cumbersome, and the need for water to submerge the tube in is restrictive, and often leads to a mess of water splatter. Certain embodiments of the present invention aim to enable better practice.

For illustration, consider an embodiment of the present invention with a circular tube having 100 mm length and a 15 mm interior. If a 3 mm thick twisted silicone ribbon in secure contact with the interior tube wall forms an air pathway with an effective 6 mm diameter around the whole length of the tube, the effective lengthening of a user's vocal tract is substantial. With a pitch in the range of 3-6 mm per revolution, the resulting airflow path length may be made to be about 5-10 times the physical tube length (˜48 cm-95 cm for a 100 mm tube). Thus, the device achieves the back-pressure benefits of a 30-100 cm straight resonance tube while remaining pocket-portable. If such an embodiment comprises means for oscillating pressure, such as Heimlich valve or the presently disclosed deformable element, the device may also effectively replace the need for insertion in water. (It is contemplated that the distal end of the device may be left open or contain a pass-through such that the device may be submerged.) These numerical values are exemplary and non-limiting; other diameter/pitch combinations may be selected to tailor resistance.

By providing a full and enabling disclosure of the structure and use of the invention, this detailed description equips those skilled in the art to understand and practice the invention in its various forms. It will be apparent that certain changes can be made in the form and detail of specific embodiments without departing from the underlying inventive concept. For instance, dimensions of the device (length, diameter) may be adjusted to target specific user groups (children vs. adults, professional singers requiring higher resistance vs. rehabilitative use requiring gentler resistance). Additional accessories could be integrated, such as a pressure gauge or visual indicator to help users monitor their airflow or pressure while using the device. These and other modifications are considered within the scope of the invention. The following claims are intended to define the invention's scope and to cover all such embodiments and modifications that fall within the equivalents of the claims.

What is claimed is:

1. An apparatus for semi-occluded vocal tract exercises, comprising:
a tubular body having a proximal end and a distal end;
an internal helical airflow path structure within said tubular body configured to increase the effective airflow path length between the proximal end and the distal end;
at least one user-occludable vent aperture in a wall of the tubular body, the vent aperture being selectively covered or uncovered by a user's digit, a removable plug, an adjustable sleeve, an adjustable valve, or other closure to modulate airflow resistance and effective path length.

2. An apparatus for semi-occluded vocal tract exercises with oscillatory resistance, comprising:
a tubular body having a proximal end and a distal end;
a removable insert defining at least one tortuous airflow path within said tubular body;
a deformable element positioned at or near the distal end of the airflow path;
wherein the deformable element periodically deforms under expiratory pressure to produce an oscillatory back-pressure in the airflow path.

3. An apparatus for semi-occluded vocal tract exercises, comprising:
a tubular body having a proximal end and a distal end;
an internal helical airflow channel extending from the proximal end to the distal end; and
an adjustable resistance element at the distal end configured to vary the airflow restriction at the channel's exit,
whereby airflow resistance is controllable without requiring any airflow path reversal or side vent aperture.

4. The apparatus of claim 1, wherein said internal airflow path structure comprises a double-helical configuration defining a descending airflow channel and an ascending airflow channel, with a partially or fully closed junction at the distal end that substantially forces airflow to reverse direction from the descending channel into the ascending channel.

5. The apparatus of claim 1, wherein said internal airflow path structure is a removable insert positioned within said tubular body.

6. The apparatus of claim 1, wherein said internal airflow path is integrally formed as a helical channel on an inner wall of said tubular body (without requiring any removable insert).

7. The apparatus of claim 5, wherein said insert is composed of a flexible elastomeric material and includes a continuous peripheral rib configured to seal against an inner wall of the tubular body.

8. The apparatus of claim 5, wherein said insert is composed of a rigid material and further comprises one or more elastomeric gasket elements to provide an airtight seal within said tubular body.

9. The apparatus of claim 5, wherein said tubular body has a non-circular cross-section and said insert is keyed to that cross-sectional shape to prevent rotation of the insert.

10. The apparatus of claim 1, wherein said closure element comprises one or more adjustable valves.

11. The apparatus of claim 1, wherein said closure element comprises a rotatable sleeve disposed around said tubular body, the sleeve having at least one opening alignable with said vent aperture to open or close it.

12. The apparatus of claim 1, further comprising a flutter valve covering one of said vent apertures, the flutter valve being configured to flex open and closed intermittently under exhaled airflow to create a pulsating resistance.

13. The apparatus of claim 1, further comprising a plurality of interchangeable inserts each defining a different internal airflow path geometry for selectively varying the airflow resistance of the apparatus.

14. The apparatus of claim 1, wherein said tubular body is constructed from an antimicrobial metal selected from copper, brass, or a silver-containing alloy.

15. The apparatus of claim 1, further comprising a suspension element configured to allow the apparatus to be worn or attached to a user's person (for example, a lanyard loop or clip).

16. The apparatus of claim 2, wherein said deformable element comprises a flexible membrane or bladder enclosing a compressible medium selected from air, silicone gel, or an elastomer, thereby providing a resilient, deformable resistance element.

17. The apparatus of claim 2, further comprising an adjustment mechanism for varying contact pressure between said deformable element and said insert; wherein said adjustment mechanism comprises a twist-actuated advancement mechanism that, upon rotation, linearly advances or retracts the deformable element relative to said insert to adjust contact pressure.

18. The apparatus of claim 2, wherein said removable insert defines a double-helix airflow path and said deformable element is positioned to interface with converging airflow from both helical paths at the distal end.

19. The apparatus of claim 2, wherein said deformable element is removable and replaceable, allowing different deformable elements to be substituted to alter the oscillation frequency or intensity characteristics.

20. The apparatus of claim 3, wherein said adjustable resistance element comprises a rotatable end cap or valve at the distal end of the tubular body, the end cap having an aperture whose effective size can be varied to finely adjust the exhalation resistance.
